(19) United States
(12) Patent Application Publication
(10) Pub. No.: US 2010/0076610 A1
(43) Pub. Date: Mar. 25, 2010

(54) Low cost automatic sprinkler assistant

(76) Inventor: Vuong Binh Hong, Costa Mesa, CA (US)

Correspondence Address: Vuong Binh Houg, 3132 Coolidge Ave, Costa Mesa, CA, 92626, US

(21) Appl. No.: 12/284,150

(22) Filed: Sep. 19, 2008

(51) Int. Cl. G05D 7/00

(52) U.S. Cl. 700/284

(57) ABSTRACT

The low cost automatic sprinkler assistant is an apparatus to help the regular sprinkler timer to become a low cost, fully automatic and zero maintenance sprinkler control system. The low cost automatic sprinkler assistant combines with the regular sprinkler timer will automatically adjust the watering time in order to keep the moisture of the irrigated land virtually unchanged within an acceptable tolerance. The low cost automatic sprinkler assistant is connected in series and between the regular sprinkler timer and the valves. If it rains, when the Relative Humidity is above 70%, the low cost automatic sprinkler assistant stops the sprinkler valves. The low cost automatic sprinkler assistant is also serves as a Relative Humidity Gauge with the tolerance of +and −5%. A general method of calculation how much water is needed to irrigate to keep the grass or land at optimum condition is also provided.

The low cost automatic sprinkler assistant is an apparatus to help the regular sprinkler timer to become a low cost, fully automatic and zero maintenance sprinkler control system. The low cost automatic sprinkler assistant combines with the regular sprinkler timer will automatically keep the moisture of the irrigated land virtually constant. A method of calculation how much water is needed to irrigate to keep the grass or land at optimum condition is also provided. The low cost automatic sprinkler assistant is connected in series and between the regular sprinkler timer and the valves.

### BACKGROUND OF THE INVENTION

There is a critical need to conserve water due to limited resources of water and an increasing population; however, it is important to ensure that the plants receive the minimum amount of water required for them to remain healthy.

How much water is needed for each kind of plant varies, and how much water is needed to irrigate the land varies greatly with different kinds of soils, climates, temperatures, air pressures, and most importantly, the amount of moisture. Temperature and moisture determine the rate of evaporation of water from the land and plants. The hotter or drier an area is, the more water needed to irrigate the plants. To determine how much water is optimum to irrigate the plants at certain times, Relative Humidity (RH) value is an important factor. The regular sprinkler timer is rigid so it is very difficult to avoid over watering or under watering. The smart sprinkler controller is much better but expensive, complicated to use and requires extensive maintenance. The present invention solves those issues by providing a very low cost, simple to operate and best of all automatic and maintenance free.

One just needs to calculate how much time is needed for the regular sprinkler timer to run for particular plants and kind of soil at 0% Relative Humidity at any time of a day. A general method to calculate that time is provided in the present invention. At the start of irrigation, the present patent will calculate and delay the amount of time needed to subtract from the set up time which based on 0% Relative Humidity. One minute is subtracted for each 10% Relative Humidity wetter. Thus for a 0% RH or total dry, the irrigation time is 100%. For a 70% RH and up which is equivalent to rain, the present invention will stop the irrigation.

For different kinds of lands or plants which require varying amounts of moisture, one just simply adjusts the watering time of the regular sprinkler timer. The rest will be taken care of by the present invention.

REFERENCE

| | | |
|---|---|---|
| 7,063,271 | June 2006 | Lashgari |
| 6,145,755 | November 2000 | Feltz |
| 5,853,122 | February 1998 | Caprio |
| 5,839,660 | November 1998 | Morgenstern, et al. |
| 5,826,792 | October 1998 | Hasslinger |
| 5,602,728 | February 1997 | Madden, et al. |
| 5,464,044 | November 1995 | Brinkerhoff |
| 5,452,747 | September 1995 | De Man |
| 5,337,777 | August 1994 | Shaw, et al |
| 5,148,826 | September 1992 | Bakhshaei |
| 5,074,468 | December 1991 | Yamamoto, et al. |
| 5,021,939 | June 1991 | Pulgiese |
| 4,962,522 | October 1990 | Marian |
| 4,834,143 | May 1989 | Bayat |
| 4,796,654 | January 1989 | Simpson |
| 4,253,606 | March 1981 | Johnson |
| 4,014,359 | March 1977 | Sanner |

All inventions above use Ground humidity in the sprinkler control system. This approach has the advantage of measuring the moisture at the ground next to the roots of the plants; however, this approach has the drawbacks of the inhomogeneous of the land. The humidity at one point of the ground can be very different to the next. This disadvantage is more profound if the ground is not level. The present invention use air relative humidity to solve that problem. There is a close relationship between the air relative humidity and the ground humidity. If we carefully utilize the Relative Humidity reading, we can indirectly control the moisture of the ground. Further more, the air Relative Humidity is a very important factor for the plants. The air temperature and moisture affects the rate of evaporation of water from the land and plants. Thus the air Relative Humidity can help us to determine how much water is needed to irrigate the land with optimum results. The smart sprinkler system controller has high accuracy but expensive and requires extensive maintenance. The present invention solves that problem by introducing a very low cost, simple to operate, automatic and best of all maintenance free.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a sprinkler system including a power supply circuit, a control circuit and a relative humidity gauge according to the present invention.

FIG. 2 shows the power supply circuit for the automatic sprinkler controller according to the present invention.

FIG. 3 shows the block diagram of the control circuit according to the present invention.

FIG. 3A shows the block diagram of the Relative Humidity wave form

FIG. 3B shows the block diagram of the one minute clock generator.

FIG. 3C shows the block diagram of the reset circuit.

FIG. 4 shows the block diagram of the relative humidity display circuit according to the present invention

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

The present invention provides a simple but effective apparatus and method to enhance the regular sprinkler timer to become a low cost, automatic, maintenance free sprinkler system controller.

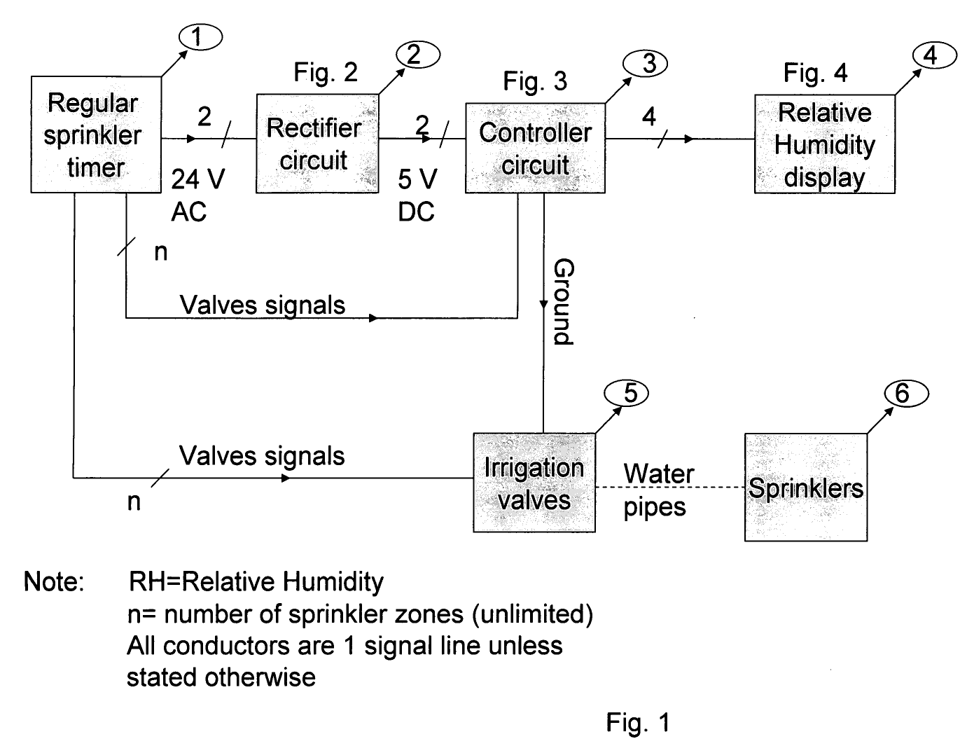

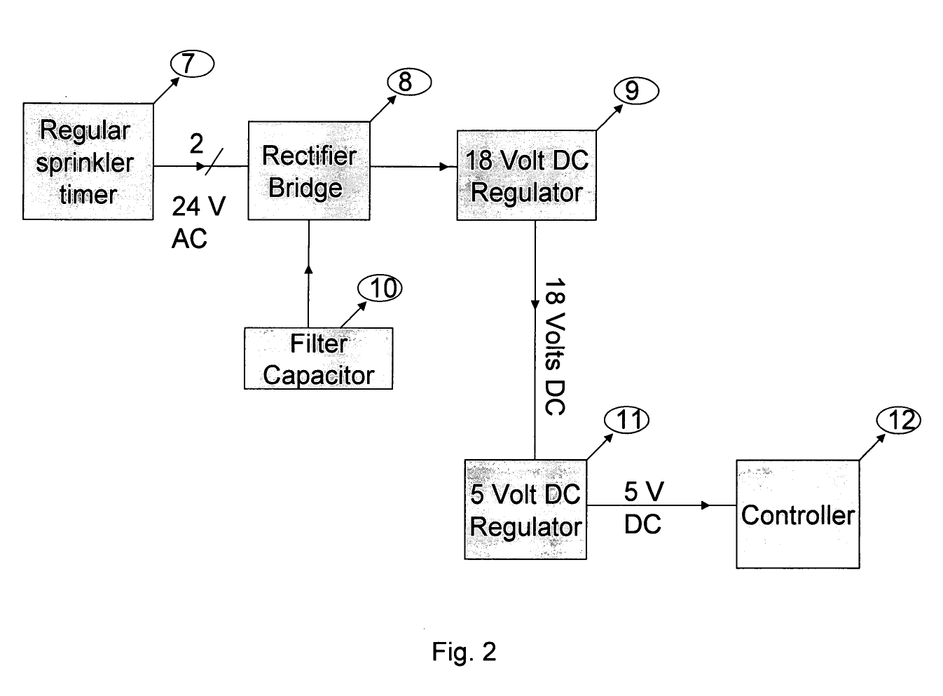

From FIG. 1, a regular sprinkler timer 1 has a 24 Volt Alternate Current (AC) power supply which can be used to energy the present invention by connecting to the rectifier 2 through the conductors 1-2. The rectifier 2 shown in FIG. 2 converts the 24 Volt AC into 5 Volt Direct Current (DC) provides the power for all components of the present invention. The Valves Signal & Common conductors 1-3 provide the controller circuit 3 all the required signals to start the process of delaying and then turn ON the Irrigation Valves 5 by relaying the Common signal to the Irrigation Valves 5. Only one zone or valve will be turn on at a time and unlimited number of valves can be turn on sequentially. The Regular Sprinkler Timer 1 provides the Irrigation Valves 5 the Valve Signals through the conductor 1-3 and the Controller Circuit 3 provides the Irrigation Valves 5 the common signal through the conductor 3-5. The Relative Humidity (RH) Display 4 displays the current RH of the environment. The conductors 3-4 provide information about the RH of the surrounding to the RH Display 4.

FIG. 2 shows the rectifier circuit to convert 24 Volt AC to 5 Volt DC. The Rectifier Bridge 8 with the help of the Filter Capacitor 10 converts the 24 Volt AC into about 30 Volts DC. The 18 Volt DC Regulator 9 brings down the DC Voltage at the output of the rectifier Bridge 8 to 18 Volt DC. The 5 Volt DC Regulator reduces the 18 Volt DC to 5 Volt DC to supply power for the present invention.

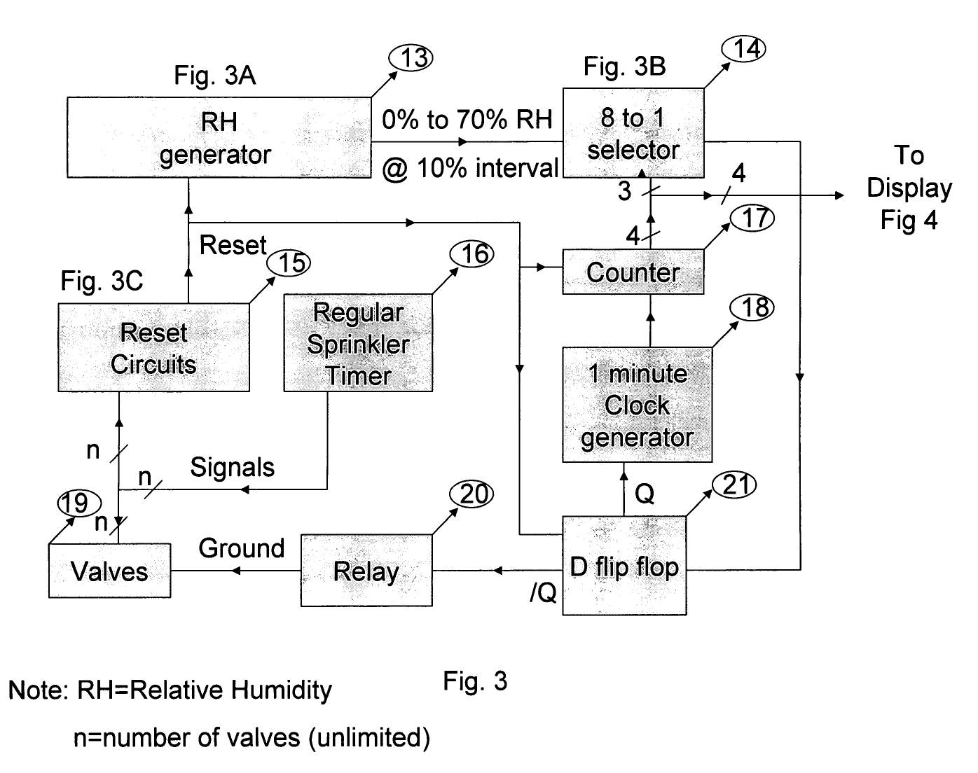

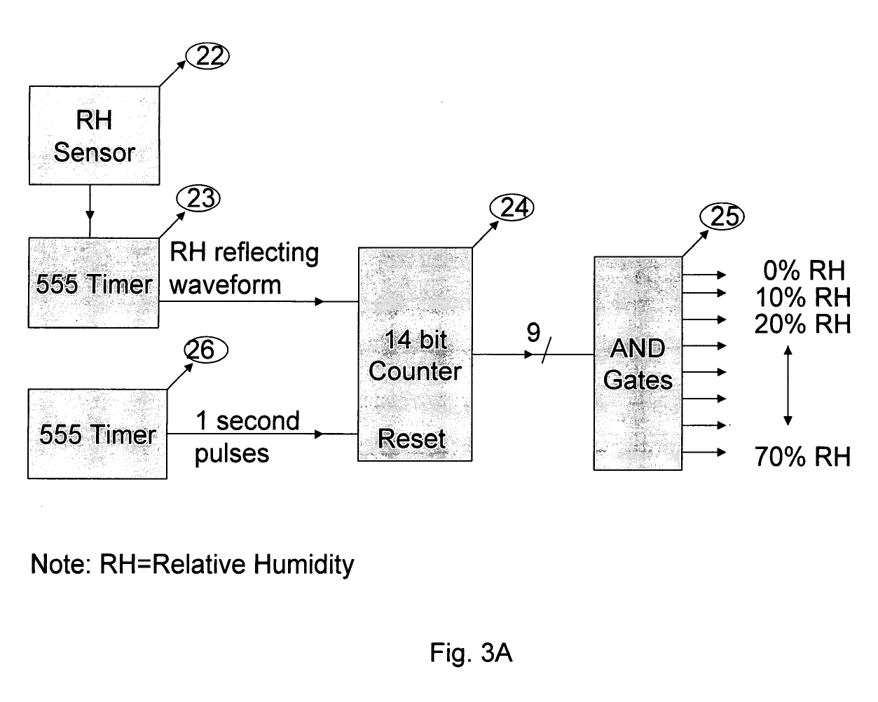

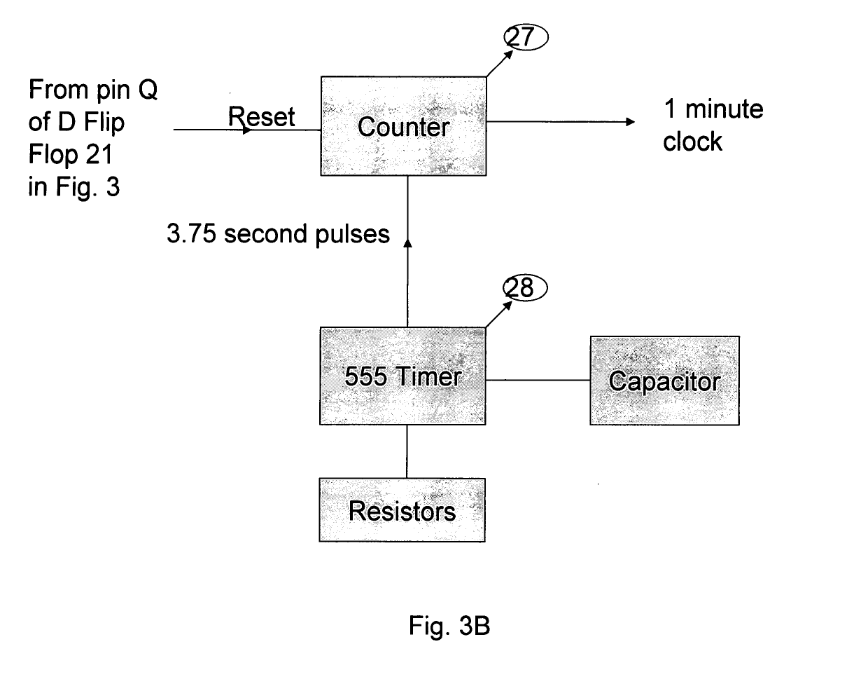

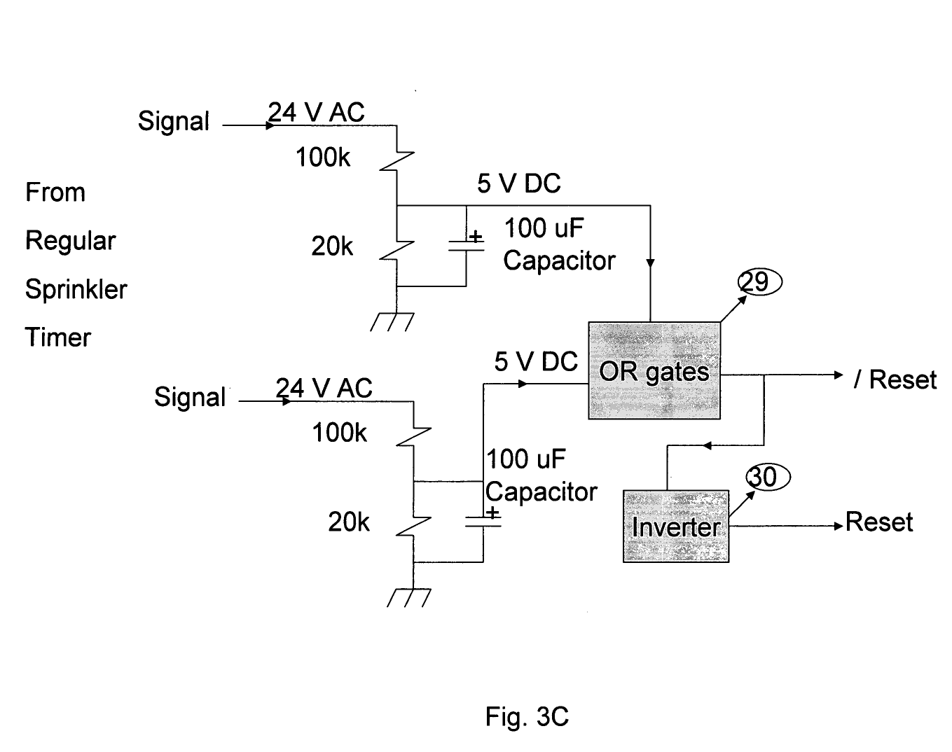

FIG. 3 shows the brain of the present invention. Based on the Relative Humidity sensor chip, the RH Waveform generator 13 generates the outputs from 0% RH to 70% RH at 10% RH intervals. The 8 to 1 Selector 14 starts to select the pin of 0% RH. If this pin 0% is high in case the RH of the surrounding is total dry, the 8 to 1 Selector 14 through the conductor 14-21 clocks the D Flip Flop 21 whose D pin connected to 5 Volt. This will turns output Q of the D Flip Flop 21 high and \Q low. If this is not the case, The 8 to 1 Selector 14 checks the next pin of 10% after 1 minute delay. The process continues until the 8 pins are checked. If the RH of the surrounding is higher than 70% such as in case of rain, the D Flip Flop 21 will not change the states of Q and \Q. The output Q of the D Flip Flop 21 when turns high will disable the 1 Minute Clock Generator 18. The Counter 17 will stop advance the counting. This stopping helps to display the current Relative Humidity of the surrounding.

When the Relay 20 receives the low signal from pin /Q of D Flip Flop 21 through conductor 20-21, it connects the Ground to the Common Signal of the Valves 19 through the conductor 19-20. The Sprinkler Valve currently has the signal high will turn ON. The conductor 16-19 connects the signals from the Regular Sprinkler Timer 16 to the Sprinkler Valves 19.

FIG. 3A shows the block diagram of circuitry to generate the 8 levels of Relative Humidity of the surrounding from 0% RH to 70% RH at 10% RH intervals. The 555 timer 23 generates the waveform reflects the surrounding RH through the RH sensor chip 22. The waveform clocks the 14 bit counter 24. The 555 timer 26 generates 1 second pulses to reset the 14 bit counter 24 through the conductor 26-24. This combination enables the outputs of 14 bit counter 24 to reflect the frequency of the RH sensor 22. The AND gates 25 create the outputs reflecting the 0%, 10%, 20%, 30%, 40%, 50%, 60% and 70% RH by selecting and adding the appropriate outputs of the 14 bit counter 24.

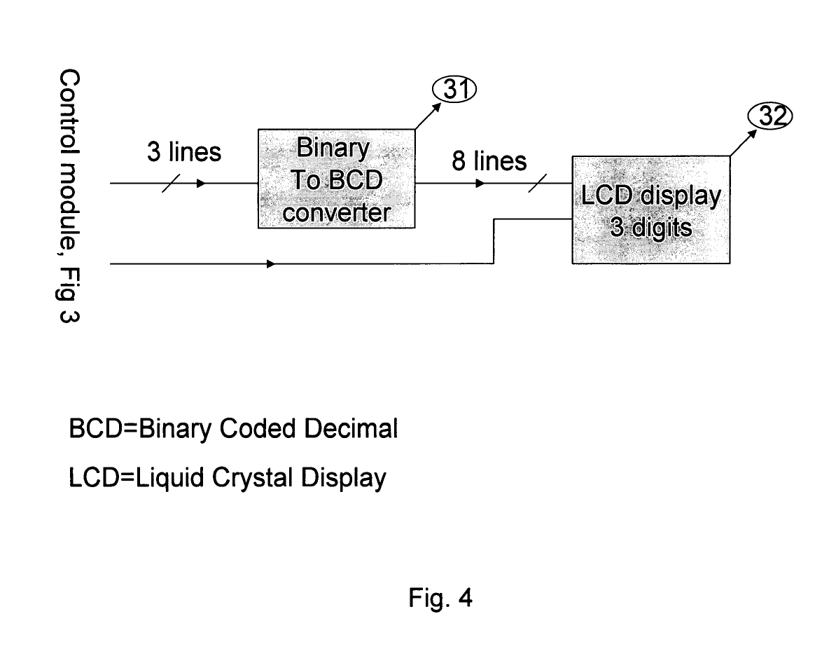

FIG. 3B shows the block diagram of the circuitry to generate the 1 minute clock. The timer 28 and appropriate capacitor and resistors generate the 3.75 second pulses. These pulses are fed to the clock pin of the counter 27 through the conductor 28-27. The counter 27 divides the 3.75 second pulses further into 1 minute clock. When pin Q of flip flop 21 in FIG. 3 changes to high state, this signal resets the counter 27 and thus stops the 1 minute clock as long as the reset pin is high. When the 1 minute clock stops, the counter 17 stops advancing and the 8 to 1 selector 14 stops advancing as well. Because the D bit of the D flip flop 21 of FIG. 3 is tight to the 5 Volts, the D flip flop will not change states until it is reset by the reset circuit 15 of FIG. 3. This will freezes the outputs of the counter 17 of FIG. 3 which help the display of FIG. 4 to display the current Relative Humidity of the air at that moment.

FIG. 3C shows the block diagram of the reset circuitry. When the Regular Sprinkler Timer 1 of FIG. 1 turns ON one of its signals, the ON signal goes trough one of the Valves signals 1-3 to the controller Circuit 3 of FIG. 3. This signal is a 24 Volt AC signal. As shown in FIG. 3C, the 24 Volt AC signal is divided between 100 k Ohm and 20 k Ohm bridge into 5 Volts AC. The 100 uF capacitor of FIG. 3C and the diode of the rectifier bridge 8 of FIG. 2 convert the 5 Volt AC to the 4.3 Volt DC. The 0.7 Volts dropped due to the diode. All the 5 Volt DC of the signals are fed through a series of OR gates 29 or multiple inputs OR gates 29. The output of the final OR gate is the low level Reset signal. This low level is fed to the input of the inverter 30 through the conductor 29-30. The output of the inverter 30 is the high level Reset. As indicated in FIG. 3, the reset signals will reset the RH generator 13, counter 17, D flip flop 21 when all signal are at low level.

FIG. 4 shows the block diagram of the circuitry to display the Relative Humidity of the surrounding. The Binary to BCD converter 31 translate the 3 signal lines from the Control module of FIG. 3 into 8 bits BCD coded. These 3 signal lines and the fourth bit of the counter 17 of FIG. 3 are connected to the inputs of the LCD 3 digit display 32. The fourth bit is used to display the number 100 when the RH of the air is higher than 70% RH. The 3 digit display will display the RH percent of the surrounding.

What is claim is:

1) A sprinkler circuit and a formula comprising: a relative humidity responsive circuit calculates and subtracts from the ON time of the regular sprinkler timer a certain amount of time based on the relative humidity (RH) of the environment; a relative humidity display with tolerance approximates ±5%; and a formula to calculate how much irrigating time is needed in order to keep the plants at optimum moisture condition.

2) The sprinkler circuit of claim 1, wherein the rectifier circuit generates 5 Volts source from the 24 Volt AC source supplied to the regular control timer.

3) The sprinkler circuit of claim 2, wherein one rectifier bridge, one 470 micro Farad capacitor, and two voltage regulators 18V and 5V are connected cascading to convert the 24 Volt AC into 5 Volt DC source

4) The sprinkler circuit of claim 1, wherein the control circuit generates eight outputs which represent 0% to 70% with intervals of 10% relative humidity. The pins at the present or higher relative humidity will be high; the lowers will be low. If the present relative humidity is higher than 70%, there is no high output;

5) The sprinkler circuit of claim 1, wherein the circuitry comprises of a relative humidity sensor chip, two timers, a 14 bit counter and a series of OR and AND gates.

6) The sprinkler circuit of claim 5, wherein the first timer generates wave form with frequency varies accordingly to the capacitance of the relative humidity sensor chip which reflects the temperature and moisture of the surrounding environment.

7) The sprinkler circuit of claim 5, wherein the second timer, one capacitor, and two resistors generate a one second pulses to reset the counter every second.

8) The sprinkler of circuit of claim 5, wherein the counter and the series of AND gates interconnect to provide the eight outputs representing 0% to 70% relative humidity at 10% intervals.

9) The sprinkler circuit of claim 1, wherein the control circuit checks from 0% to 70% RH starting from 0% RH and going up until finds a high output or exhausting all the outputs without any find.

10) The sprinkler circuit of claim 9, wherein a timer and a counter generate one minute pulses. To have different timing pulses, we just need to change the capacitance, the resistors or both.

11) The sprinkler circuit of claim 9, wherein a selector with clock input connecting to one minute pulses from claim 10 selects each output every one minute starting from 0% RH and end at a high output pin or until get to 70% RH.

12) The sprinkler circuit of claim 9, wherein when the fourth output of the counter goes high, the clock to the counter is disable with an OR gate.

13) The sprinkler circuit of claim 9, wherein a D flip flop or equivalent changes states from negative to positive if a positive pin is selected from the 0% to 70% relative humidity outputs. After changing state, the D flip flop will not change state again until the D flip flop is reset at the start of the new zone.

14) The sprinkler circuit of claim 1, wherein a relay SPST connects the ground wire of the control circuit to the common wire of the valves when the output of the D flip flop is high. The valves will be turned on. They will be turned off at the end of the time schedule of the timer for that zone.

15) The sprinkler circuit of claim 1, wherein a LCD displays the value of the RH of the surrounding with the tolerance of ±5% RH.

16) The sprinkler circuit of claim 15, wherein a binary to BCD decoder is used to decode the first three outputs of the counter in claim 10.

17) The formula of claim 1; comprising a method to calculate how much irrigating time is needed in order to keep the plants at optimum moisture condition and how much time needed to set the regular sprinkler timer.

18) The calculation of claim 17, wherein is calculated as follows: As a rule of thumb, for optimum moisture condition we need 1 in of rain per day. The irrigation time or watering time of the regular sprinkler timer is calculated as follow:
$$\begin{matrix}1 in of rain = 6 , 272 , 640 cu in \text{/} acre \times 1 acre / \\ 43 , 560 sq ft \times 0.004329 gal \text{/} cu in \\ = 0.623 gal \text{/} sq ft per day\end{matrix}$$
for a 5-25 GPM or average 15 GPM irrigation control system at home,
1 in of rain=0.623 gal/sq ft/15 gal per min=0.042 min/sq ft
Thus 1 in of rain approximately equals 0.05 minutes per square foot per day.
Assume the average RH of the region is 50%, one needs to set the regular sprinkler timer an amount calculated as:
0.05 minutes/sqft×irrigation area in sqft+50% RH/10% RH/1 minute
Example: for a 100 sqft area, the time to be set on the regular sprinkler timer is:
0.05×100+50/10=10 minutes/day
